(19) United States
(12) Patent Application Publication
(10) Pub. No.: US 2008/0068938 A1
(43) Pub. Date: Mar. 20, 2008

(54) COIL-MANUFACTURING METHOD AND OBJECTIVE-LENS DRIVING APPARATUS

(75) Inventor: Hiroshi SHINOZUKA, Fuchu-City (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Samsung Storage Technology Corporation, Kawasaki-City (JP)

(21) Appl. No.: 11/854,207

(22) Filed: Sep. 12, 2007

(30) Foreign Application Priority Data
Sep. 20, 2006 (JP) 2006-254451

(51) Int. Cl. G11B 7/00

(52) U.S. Cl. 369/44.11; 29/605

(57) ABSTRACT

Of the two coil units 2-1 and 2-2 constituting an upper-stage coil unit, the coil unit 2-1 is passed through the winding of a coil unit 1-2 that constitutes a lower-stage coil unit, together with a coil unit 1-1, from inside to outside of the winding. A wire led inwards from the coil unit 2-1 of the upper-stage coil unit is passed through the inside of the winding of the coil unit 1-1 of the lower-stage coil unit, and is pulled outside the winding of the coil unit 1-1.

### CROSS-REFERENCE TO RELATED APPLICATIONS

This invention is based upon and claims the benefit of priority from the prior Japanese Patent Application No. 2006-254451, filed on Sep. 20, 2006, the entire contents of which are incorporated herein by reference.

### BACKGROUND OF THE INVENTION

1. Field of the Invention

The present invention relates to a coil manufacturing method and an objective-lens driving apparatus for driving an objective lens having serial coils made by the method. More particularly, the invention relates to a method of manufacturing, for example, a double coil, and also to an apparatus for driving an objective lens using the double coil.

2. Description of the Related Art

Generally, an optical head focuses a laser beam on the recording surface of an optical recording medium such as an optical disk, thereby recording data on the optical recording medium. The optical head also applies a laser beam to the recoding surface and determines the data from the intensity of the light reflected from the recording surface to reproduce the data. To perform these functions, the optical head has an objective lens and an objective-lens driving apparatus. The apparatus drives an objective lens, which focuses a laser beam on the recording surface of an optical disk to record data on, and reproduces the data from, the optical disk. In the apparatus, the electromagnetic force of coils is used to control the tracking, focusing and tilting.

One type of an objective-lens driving apparatus has a double coil composed of two coil units that differ in number of turns and the winding direction (e.g., direction in which wire is wound) so that the intensity and direction of magnetic flux may be minutely controlled. The two coil units are connected by a leading line. An example of this apparatus is an optical pickup apparatus (see Patent Document: Jpn. Pat. Appln. Laid-Open Publication No. 2004-110891). In this optical pickup apparatus, a focus coil, a track coil and a tilt coil are arranged in a coil holder. The intersection of these coils is located in an air gap between a magnet and a yoke. The magnet is so shaped that its top and bottom end parts broader than its center part.

A double coil composed of two coil units and another double coil composed of two coil units may be arranged, one above the other. In this case, the line connecting the coil units of the lower double coil is clamped between that part of one coil unit of the upper double coil, which overlaps the corresponding part of one coil unit of the lower double coil. Therefore, the section composed of the two double coils has a height greater than otherwise by the thickness of the leading line.

In the optical pickup apparatus described above, the focus coil and the tilt coil are laid one above the other, the magnet and the yoke are so shaped that the magnetic flux density may be higher at the focus coil and the tilt coil than in the space surrounding these coils. The above Patent Document is silent about any method of laying serial coils one upon another, forming two or more stages of coils.

### BRIEF SUMMARY OF THE INVENTION

It is an object of the present invention to provide a coil manufacturing method and an objective-lens driving apparatus. The method can produce a coil which is composed of serial coils each consisting of two or more coil units, which can restrain an overall height of a serial coil and which can control an objective lens in various directions as desired.

In an aspect of the present invention, there is provided a coil manufacturing method including: a step of laying at least two serial coils one above the other, each serial coil having an odd number of turns and being composed of at least two coil units are connected through a conductive member; a step of connecting a wire led outwards from one of the upper-stage coil units constituting the upper-stage serial coil to a wire led inwards from the other coil unit of the upper-stage coil units; a step of connecting a wire led outwards from one of the lower-stage coil units constituting the lower-stage serial coil to a wire led inwards from the other coil unit of the lower-stage coil units; a step of passing one of the coil units constituting the upper-stage or lower-stage coil unit, from inside to outside through the winding of the other coil unit constituting the lower-stage or upper-stage coil unit; a step of passing the other of the coil units constituting the lower-stage or upper-stage coil unit, from outside to inside through the winding of the other coil unit constituting the upper-stage or lower-stage coil unit; and a step of pulling outwards a wire led inwards from the upper-stage or lower-stage coil unit, through the winding of the opposing lower-stage or upper-stage coil unit.

### BRIEF DESCRIPTION OF THE DRAWINGS

FIG. 1 is a diagram showing a schematic configuration of an optical head according to a first embodiment of the present invention;

FIG. 2 is a perspective view of an objective-lens driving apparatus according to the first embodiment of the invention;

FIG. 3 is four views of the objective-lens driving apparatus according to the first embodiment of the invention;

FIG. 4 is a diagram explaining a condition before the focus coil and tilt coil according to the first embodiment of the invention are assembled;

FIG. 5 is a diagram explaining a condition after the focus coil and tilt coil according to the first embodiment of the invention have been assembled;

FIG. 6 is a diagram explaining a condition in which a focus coil according to the first embodiment of the invention is incorporated into the objective-lens driving apparatus;

FIG. 7 is a diagram explaining a condition in which a track coil according to the first embodiment of the invention is incorporated into the objective-lens driving apparatus;

FIG. 8 is a diagram explaining a condition after the focus coil, tilt coil and track coil according to the first embodiment of the invention have been incorporated into the objective-lens driving apparatus;

FIG. 9 is a diagram explaining the arrangement of the focus coil, track coil and tilt coil according to the first embodiment of the invention;

FIG. 10 is a diagram explaining the shape of a focus coil and that of a tilt coil, both according to the first embodiment of the present invention;

FIG. 11A, FIG. 11B, FIG. 11C and FIG. 11D are diagrams explaining double coils, each composed of two coil units which have an odd number of turns each and which have been made by a coil manufacturing method according to the first embodiment of the invention;

FIG. 12A, FIG. 12B and FIG. 12C are diagrams explaining double coils, each composed of two coil units which have an even number of turns each and which have been made by a coil manufacturing method according to the first embodiment of the invention;

FIG. 13A and FIG. 13B show two double coils that have been simply laid one above the other;

FIG. 14 is a diagram explaining double coils, each composed of two coil units which have an even number of turns each and which have been made by a coil manufacturing method according to a second embodiment of the invention;

FIG. 15A and FIG. 15B are diagrams explaining double coils, each composed of two coil units which have an odd number of turns each and which have been made by a coil manufacturing method according to the second embodiment of the invention;

FIG. 16A and FIG. 16B are diagrams explaining a method of manufacturing a first coil according to a modification of the second embodiment of the present invention, which has an add number of turns;

FIGS. 17A, 17B, 17C and 17D are diagram explaining a method of manufacturing a second coil according to a modification of the second embodiment of the invention, which has an even number of turns;

FIG. 18A and FIG. 18B are diagrams explaining a method of manufacturing a first coil according to another modification of the second embodiment of the invention, which has an odd number of turns; and

FIG. 19A, FIG. 19B, FIG. 19C and FIG. 19D are diagrams explaining a method of manufacturing a second coil according to still another modification of the second embodiment of the invention, which has an odd number of turns.

### DETAILED DESCRIPTION OF THE INVENTION

An objective-lens driving apparatuses according to the embodiments of the present invention and a coil manufacturing methods that can be used to manufacture the objective-lens driving apparatuses will be described with reference to the accompanying drawings. The components shown in each drawing, which are identical to those shown in any other drawing, are designated by the same reference numerals and will not be described repeatedly.

### First Embodiment

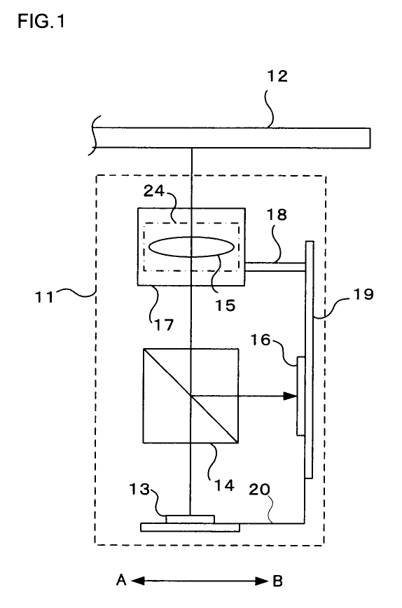

The optical pickup head according to the first embodiment of the present invention is designed to focus a light beam on the recording surface of an optical disk 12, thereby recording data or reproducing data, as is illustrated in FIG. 1. The optical pickup head 11 is arranged, opposing the recording surface of the optical disk 12. It is supported by a movable support mechanism (not shown) and can be moved in the radial direction of the optical disk 12, i.e., in the directions of arrows A and B.

The optical pickup head 11 includes a semiconductor laser 13, a beam splitter 14, a photoelectric converter 16, a flexible printed circuit board 18, a printed circuit board 19, a flexible printed circuit board 20, and an objective-lens driving apparatus 17.

The semiconductor laser 13 is configured to emit a laser beam. The beam splitter 14 is designed to focus the laser beam. The photoelectric converter 16 is a light receiving element. The flexible printed circuit board 18, the printed circuit board 19 and the flexible printed circuit board 20 are connected to external circuits and the like (not shown). The external circuits are designed to modulate and demodulate data.

The objective-lens driving apparatus 17 is configured to drive an objective lens 15 in the focusing, tracking and tilting direction, by virtue of Lorentz force generated by a plurality of coil units. The objective lens 15 receives the laser beam from the semiconductor laser 13 and focuses the beam on the recording surface of the optical disk 12.

Thus, in the optical pickup head 11, the semiconductor laser 13 emits a laser beam modulated in accordance with the data to be recorded, and the laser beam is focused on the optical disk 12, passing through the beam splitter 14 and the objective lens 15. The data is thereby recorded on the optical disk 12.

In the optical pickup head 11, too, the semiconductor laser 13 emits a laser beam at a constant level. This laser beam passes through the beam splitter 14 and the objective lens 15 and is focused on the optical disk 12. The optical disk 12 reflects the laser beam, which is adversely applied through the objective lens 15 to the beam splitter 14. The beam splitter 14 refracts the laser beam, which is applied to the photoelectric converter 16. The data is thereby reproduced from the optical disk 12.

The objective lens 15 is supported by the objective-lens driving apparatus 17 and can be moved to perform focusing control, tracking control and tilting control. The control coils, which move the objective lens 15 to perform the focusing control, tracking control and tilting control, are connected to the printed circuit board 19 via the flexible printed circuit board 18.

The semiconductor laser 13 is connected to the printed circuit board 19, too, via the flexible printed circuit board 20. The photoelectric converter 16 is electrically and mechanically connected to the printed circuit board 19. The optical pickup head 11 is electrically connected by the printed circuit board 19 to an external circuit. Therefore, in the optical head pickup 11, the semiconductor laser 13 and the objective-lens driving apparatus 17 can therefore be controlled and the signals generated by the photoelectric converter 16 can be output.

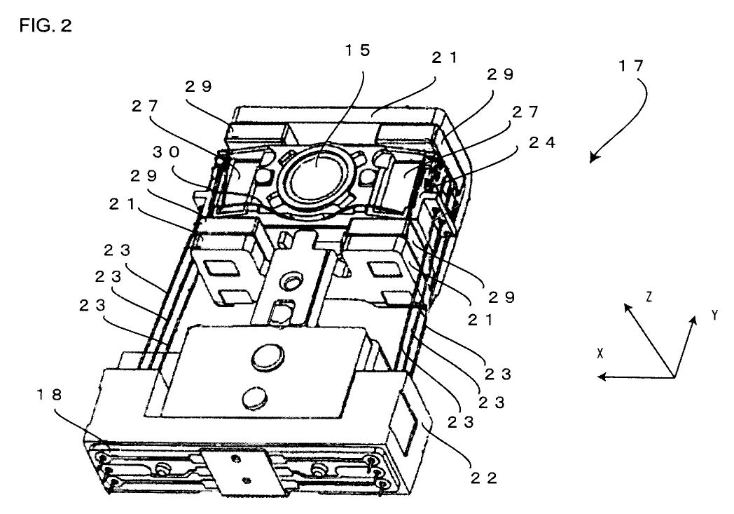

As shown in FIGS. 2 and 3, the objective-lens driving apparatus 17 has a lens holder 24. The lens holder 24 holds the objective lens 15 such that the lens 15 can move. The lens holder 24 holds the focusing control coil and tilting control coil, too, such that these control coils can be removed. Thus held by the lens holder 24, the objective lens 15 can move in both the focusing direction and the radial direction and can incline to the radial direction.

Three wires 23 are secured at one end to a side of the lens holder 24 as viewed in the radial direction. The other ends of three wires 23 are fixed to a wire holder 22.

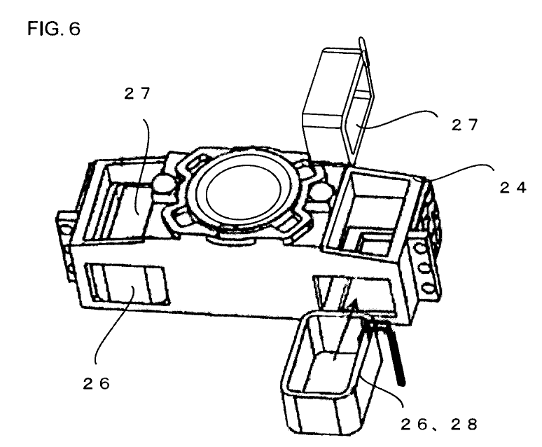

As shown in FIG. 6, a focus coil 26 composed of a pair of coil parts, a tilt coil 28 composed of a pair of coil parts, and a track coil 27 composed of a pair of coil parts are attached to the lens holder 24. These coils 26, 27 and 28 are provided to control the motion and tilting of the objective lens 15.

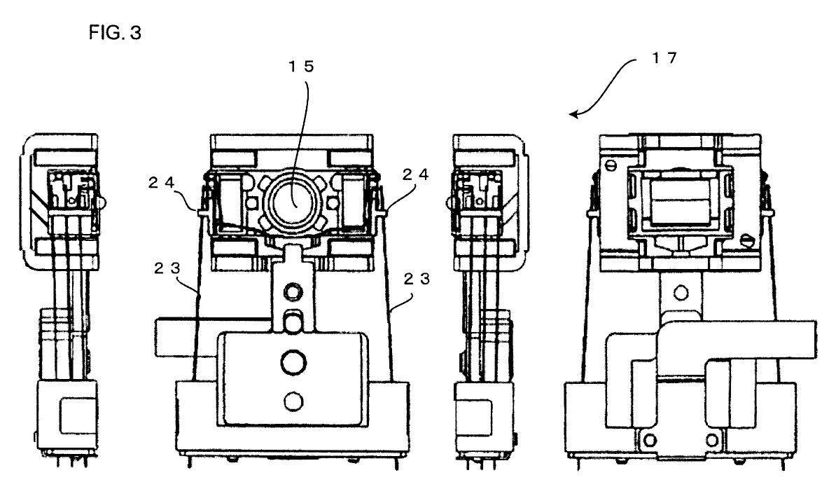

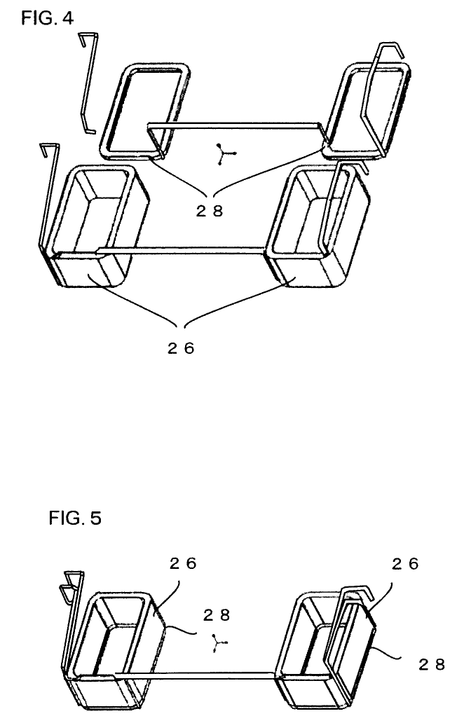

As shown in FIGS. 4 and 5, the focus coil 26 has two coil parts, each having one end portion led outwards from the winding and the other end portion led inwards into the winding. The focus coil 26 generates Lorentz's force that adjusts the displacement of the objective lens 15 in a focusing direction with respect to the optical disk 12.

As shown in FIGS. 4 and 5, the tilt coil 28 has two coil parts, each having one end portion led outwards from the winding and the other end portion led inwards into the winding. The tilt coil 28 generates Lorentz's force that adjusts the inclination of the objective lens 15 with respect to the optical disk 12.

The track coil 27 generates Lorentz's force that adjusts the displacement of the objective lens 15 with respect to the tracking direction, i.e., the radial direction of the optical disk 12.

As shown in FIGS. 4 and 5, the focus coil 26 is laid above the tiling coil 28. That is, the focus coil 26 and the tilt coil 28 are laid one above the other (see FIG. 5) and are then incorporated into the objective-lens driving apparatus 17 as shown in FIG. 6. The end portions of each coil part, which are led outwards and inwards, are arranged at almost the same position in the lens holder 24. An extension line 30 connecting the two coil parts constituting the focus coil 26, and the extension line 30 connecting the two coil parts constituting the tilt coil 28 are arranged at almost the same position in the lens holder 24. Both the coil parts constituting the focus coil 26 and the coil parts constituting the tilt coil 28 are wound in the rotational direction around the Z axis.

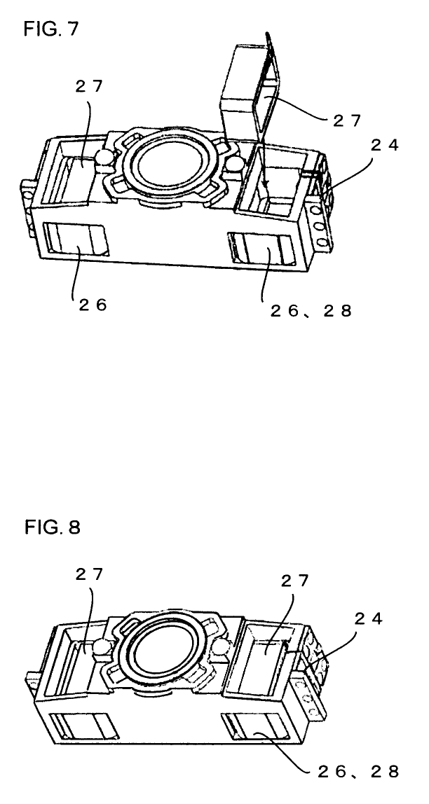

The track coil 27 is arranged within the windings of the focus coil 26 and the tilt coil 28. The focus coil 26 and the tilt coil 28, which are laid one above the other, have been inserted (or incorporated) into the lens holder 24 as shown in FIG. 6, along the Y axis through an opening made in one side of the lens holder 24. As shown in FIG. 7, the track coil 27 has been inserted into the lens holder 24 along the Z axis through an opening made in the top of the lens holder 24. The winding of the track coil 27 is wound around the Y axis in the rotational direction. After the focus coil 26, the tilt coil 28 and the track coil 27 have been inserted into the lens holder 24, the objective-lens driving apparatus 17 assumes such an outer appearance as shown in FIG. 8.

The two coil units that constitute the focus coil 26 (not shown in FIG. 2) are arranged on both sides of the objective lens 15. As shown in FIG. 2, these two coil units are connected by the extension line 30. A pair of other coil units, which have almost the same cross-sectional shape as these coil units, are attached to the lower surfaces of the two coil units constituting the focus coil 26. Thus, the focus coil 26 and the tilt coil 28 (not shown in FIG. 2) form a vertically two-stage structure. The two coil units constituting the tilt coil 28 are connected by the extension line 30, too.

Moreover, the lens holder 24 is arranged in a base (i.e., base member) 21. Four magnets 29 magnetized in the Y direction are interposed between the lens holder 24 and the base 21.

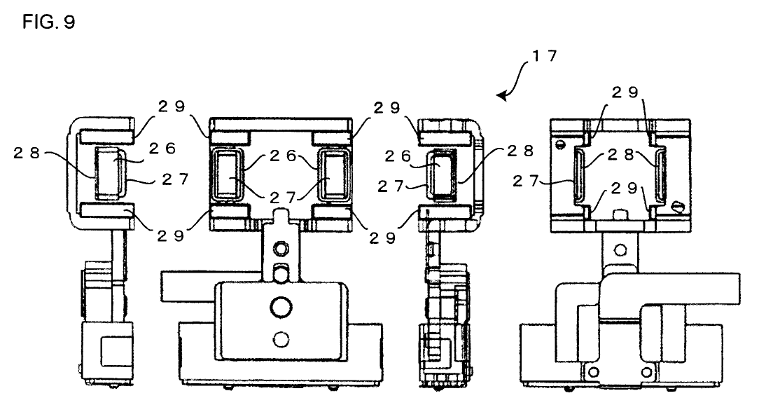

FIG. 9 shows the structure in which the three wires 23, the lens holder 24, the objective lens 15 and the like are removed from the objective-lens driving apparatus 17. The four magnets 29, the focus coil 26, the track coil 27, the tilt coil 28 and six wires (not shown in FIG. 9) constitute an actuator. In the actuator, the focus coil 27 and the tilt coil 28 generate Lorentz force. Therefore, the actuator functions as a drive means for driving the objective lens 15 in the focusing direction, tracking direction and the tilting direction. Thus, the Lorentz force generated by the four magnets 29 can move or tilt the lens holder 24 that is supported movable with respect to the base 21.

The shapes of the focus coil 26 and the tilt coil 28 according to the present embodiment will be described in detail. As shown in FIG. 10, the coil units, which are components of a double coil, are substantially a rectangular hollow core. The other of the two coil units constituting the focus coil 26 has a winding whose cross section is almost rectangular and has inner diameters A and B (A≦B). One of the two coil units constituting the tilt coil 28 has a winding whose opposing sides have, respectively, length C and length D (C≦D). Note that Length C≦inner diameter A, and length D≦inner diameter B. That is, of the sides of one coil unit of the focus coil 26, the smaller one has a greater area than the area defined by the inner diameter of the other coil unit. Also, of the sides of one coil unit of the tilt coil 28, the smaller one has a greater area than the area defined by the inner diameter of the other coil unit. If this relation holds, it is possible to pass one coil unit through the other coil unit.

In the coil manufacturing method according to the present embodiment, a coil is made, which is composed of two serial coils laid one above the other, each consisting of at least two or three coil units that are connected by conducting members such as the extension lines 30.

The objective-lens driving apparatus 17 according to this embodiment is so designed to be thinner and operate more efficiently. To this end, the focus coil 26 and the tilt coil 28 are combined and specifically arranged, thus forming a double coil (i.e., combination of the focus coil 26 and the tilt coil 28), which has a reduced height.

The focus coil 26 and the tilt coil 28, used as control coils, have the winding-start part located at the inner circumference and the winding-end part located at the outer circumference, because of the restriction imposed on their manufacture. Inevitably, to produce a double coil composed of two coil units, the wire led from the coil unit wound first lies inside the coil unit wound later.

The position of the extension line 30 or that of the wire led from any coil unit differs, in accordance with whether the coil unit has turn layers in odd number or in even number. Two double coils each consisting of two coil units are laid one above the other, thereby to combine the focus coil 26 and the tilt coil 28 according to this embodiment, in the following ways.

(1) If the Coil Unit has Turn Layers in Odd Number
Coil wound first:
   Winding-start part is located inside and on upper side
   Winding-end part is located outside and on lower side
Coil wound later:
   Winding-start part is located inside (upper and lower)
   Winding-end part is located outside (lower and upper)

(2) If the Coil Unit has Turn Layers in Even Number
Coil wound first:
   Winding-start part is located inside
   Winding-end part is located outside and upper side
Coil wound later:
   Winding-start part is located inside (upper and lower)
   Winding-end part is located outside (upper and lower)

### (1) If any Coil Unit Used has Turn Layers in Odd Number

To assemble the focus coil 26 and the tilt coil 28, two coil units for constituting the tilt coil 28 are first made by winding wires. Then, the two coil units for the focus coil 26 are made by winding wires.

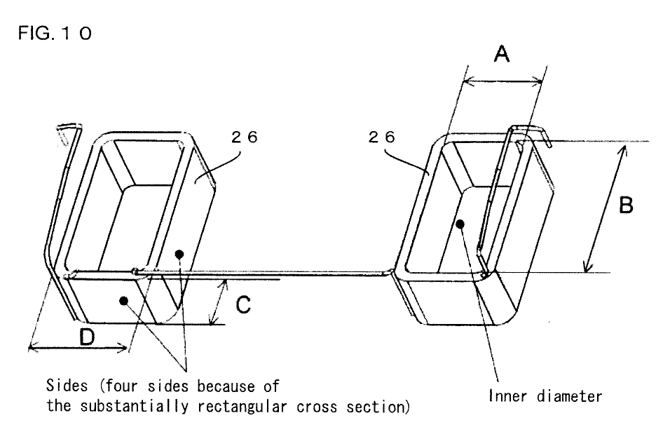

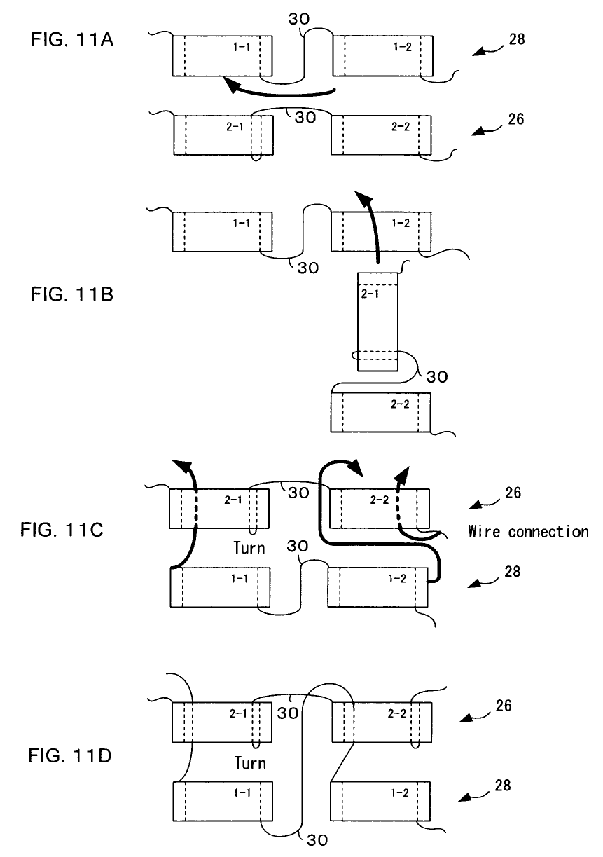

In the coil manufacturing method according to this embodiment, two coil units (upper-stage coil units) 2-1 and 2-2 are prepared to constitute the upper-stage serial coil such as the focus coil 26. As shown in FIG. 11A, the wire bent back and led upwards from inside the winding of the coil unit 2-1 is connected to the wire led upward from outside the winding of the coil unit 2-2, by using the extension line 30.

Further, two other coil units (lower-stage coil units) 1-1 and 1-2 are prepared to constitute the lower-stage serial coil such as the tilt coil 28. The wire led downwards from inside the winding of the coil unit 1-1 is connected to the wire led upward from outside the winding of the coil unit 1-2, by using the extension line 30.

The winding-start parts of the coil units 1-1 and 1-2 first wound to form the tilt coil 28 lie outside the winding and above the same. The winding-end parts of these coil units 1-1 and 1-2 lie inside the winding and below the same.

The winding-start parts of the coil units 2-1 and 2-2 wound later to form the focus coil 26 lie outside the winding and above the same. The winding-end parts of the coil units 2-1 and 2-2 lie inside the winding and below the same.

Then, as shown in FIG. 11B, the coil unit 2-1 is passed through the winding of the coil unit 1-2 from inside to outside (that is, upwards in FIG. 11B). In this case, the coil unit 2-1 has a smaller area than that of the coil unit 1-2 which is defined by the inner diameter of the winding of the coil unit 1-2.

Subsequently, as shown in FIG. 11C, the wire led outwards from the coil unit 1-1 is passed through the winding of the coil unit 2-1 and is pulled out of the coil unit 2-1. The coil unit 1-2 is also passed through the winding of the coil unit 2-2, from outside to the inside (that is, upwards in FIG. 11C). In this case, the coil unit 1-2 has a smaller area than that of the coil unit 2-2 which is defined by the inner diameter of the winding of the coil unit 2-2. The winding-end part of the coil unit 2-2 is bent back from inside and led upwards. Since the coil units are so connected, the focus coil 26 and the tilt coil 28, both according to this embodiment are obtained as shown in FIG. 11D.

The coil units 1-1, 1-2, 2-1 and 2-2, all shown in FIG. 11A to FIG. 11D, have an odd number of turns. In other words, if the wires led outwards from the coil unit 2-1 and 2-2 and the wires led inwards from the coil units 2-1 and 2-2 are formed on the opposing sides with respect to the windings of the coil units 2-1 and 2-2, the wire led inwards from the coil unit 1-1 is passed through the winding of the coil unit 2-2 and connected to the wire led outwards from the coil unit 1-2, thus forming the extension line 30.

That is, in the objective-lens driving apparatus 17, the wire led inwards from the coil unit 1-1 of the tilt coil 28 passes extends through the winding of the coil unit 2-2 of the focus coil 26, from above the coil unit 2-2, and is connected to the wire led outwards from the coil unit 1-2 of the tilt coil 28.

### (2) If any Coil Unit Used has Turn Layers in Even Number

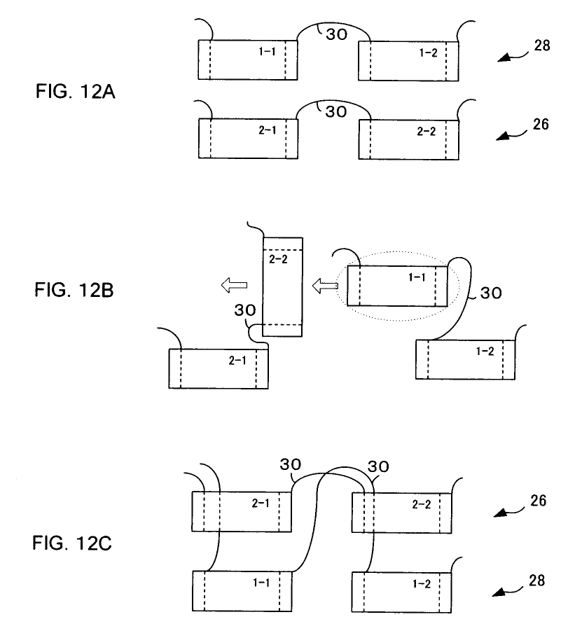

In the coil manufacturing method according to this embodiment, as shown in FIG. 12A, the wire led outwards from one of the coil units 2-1 and 2-2 constituting the focus coil 26 is connected to the wire led inwards from the other of these coil units, thus forming the extension line 30.

The wire led outwards from one (coil unit 1-1) of the coil units 1-1 and 1-2 constituting the tilt coil 28 is connected to the wire led inwards from the other (coil unit 1-2) of these coil units, thus forming the extension line 30.

The winding-start parts of the coil units 1-1 and 1-2 first wound to form the tilt coil 28 lie inside the winding and at the upper part thereof. Moreover, the winding-end parts of the coil units 1-1 and 1-2 lie outside the winding and at the upper part thereof.

The winding-start parts of the coil units 2-1 and 2-2 wound later to form the focus coil 26 lie inside the winding and at the upper part thereof. In addition, the winding-end parts of the coil units 2-1 and 2-2 lie outside the winding and at the upper part thereof. That is, the coils 26 and 28 have their winding-start part and winding-end part formed on the same side.

As shown in FIG. 12B, the coil unit 1-1 is passed through the winding of the coil unit 2-2, from inside to outside (that is, from the right to the left in FIG. 12B). In this case, the coil unit 1-1 has a smaller area than that of the coil unit 2-2 which is defined by the inner diameter of the winding of the coil unit 2-2.

Next, as shown in FIG. 12C, the wire led inwards from the coil unit 1-1 is passed through the inside of the winding of the coil unit 2-1 and led out of the coil unit 2-1. Thus, if the coil units have turn layers in even number, too, the focus coil 26 and tilt coil 28 according to the present embodiment can be obtained.

Each of the coil units 1-1, 1-2, 2-1 and 2-2 has an even number of turns. In FIG. 12C, the wires led outwards from the coil units 2-1 and 2-2 and the wires led inwards from the coil units 2-1 and 2-2 may be formed on the same side of the winding of the coil unit 2-1 and on the same side of the winding of the coil unit 2-2. If this is the case, the wire led outwards from the coil unit 1-1 is passed through the inside of the winding of the coil unit 2-2 and connected to the wired led outwards from the coil unit 1-2, thereby forming the extension line 30.

That is, in the objective-lens driving apparatus 17, the wire led outwards from the coil unit 1-1 of the tilt coil 28 extends downward, passes through the inside of the winding of the coil unit 2-2 of the focus coil 26 and is connected to the wire led inwards from the coil unit 102 of the tilt coil 28.

As mentioned above, the objective-lens driving apparatus 17 according to the present invention has two double coils, i.e., the focus coil 26 and the tilt coil 28. A part of one double coil (i.e., coil unit 1-1 in the embodiment) can be passed through a part of the other double coil (i.e., the coil unit 2-2 in the embodiment).

In the objective-lens driving apparatus 17, two double coils can be laid one above the other, no matter whether any coil used has an odd number of turns or an even number of turns. Hence, both a coil for focusing control and a coil for tilting control can be provided, in spite of the restriction imposed on their manufacture. Furthermore, the focus coil 26 and the tilt coil 28 may be set in contact or spaced apart from each other.

It will be explained how the objective-lens driving apparatus 17 according to this embodiment, configured as described above, operates.

When an electric current flows in the coil units constituting the focus coil 26 shown in FIG. 5, in counterclockwise direction around the X axis, a drive force is generated, which acts along the Z axis as described by Fleming's rule. As a result, a movable unit assembled as carriage for the lens holder 24 supported by the wires 23, the focus coil 26, the track coil 27, the tilt coil 28 and the objective lens 15 is moved by the magnets 29 and the Lorentz force generated from the current, in the positive direction (+Z) along the Z axis.

When the electric current flows in the coil units constituting the focus coil 26, conversely in clockwise direction around the Z axis, the movable unit moves in the negative direction (−Z) along the Z axis.

When an electric current flows in the coil units constituting the track coil 27, in clockwise direction around the Y axis, a drive force is generated, which acts along the positive direction (+X) along the X axis. In this case, the movable unit moves in the positive direction (+X) along the X axis.

When the electric current flows in the coil units constituting the track coil 27, conversely in counter clockwise direction around the Y axis, the movable unit moves in the negative direction (−X) along the X axis.

One of the coil units constituting the tilt coil 28 is made by winding a wire in the same direction as the wires of the coil units constituting the focus coil 26, while the other coil unit of the tilt coil 28 is made by winding a wire in the direction opposite to the winding direction of the coil units constituting the focus coil 26. Therefore, when a current flows in the positive direction along the Z axis in one of the left and right coil units constituting the tilt coil 28, the other coil unit generates a force that acts in the negative direction along the Z axis. As a result, the other coil unit rotates around the Y axis being the center of rotation.

Thus, in the present invention, the height loss of the focus coil 26 and the tilt coil 28, which may be generated when the focus coil 26 and the tilt coil 28 are laid one above the other, can be suppressed. The coil height defined by the focus coil 26 and the tilt coil 28 and physically used can therefore be effectively utilized.

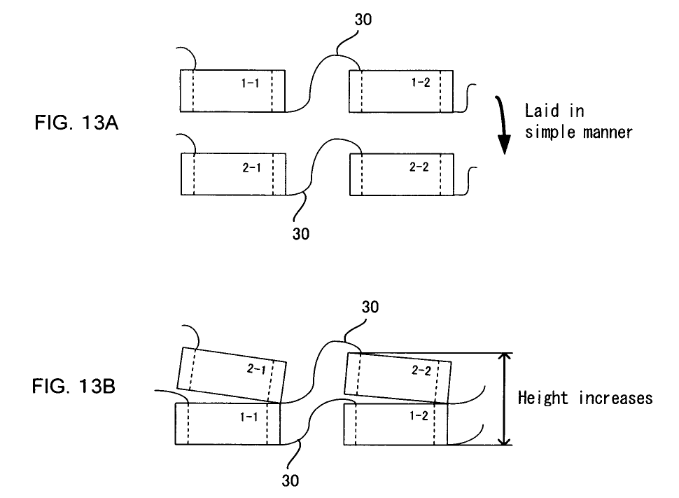

As a comparative example, two double coils may be simply laid one above the other as shown in FIG. 13. More precisely, two double coils may be arranged as illustrated in FIG. 13A. In this case, the extension line 30 and the like lie between the double coils as shown in FIG. 13B, whereby a gap develops between the double coils. Assume that each coil is composed of coil units, each made of a wire having a diameter of 0.1 mm, and has a coil height of 1.5 mm. Then, the coil composed of the double coils laid one above the other will have a height loss of 0.1 mm. This height loss is about 6.7%, i.e., 0.1 mm/1.5 mm, for the effective region.

In the present invention, as shown in FIG. 11A through FIG. 11D, two or more double coils, each consisting of two or more coil units connected together. In each coil unit, a part of one coil unit is passed through a part of the other coil unit. Then, the double coils are laid one above the other. Hence, the extension line 30 is not interposed between the double coils. The focus coil 26 and the tilt coil 28 can therefore be combined without any gap between them, and no height loss is generated at all. The embodiment of this invention can have high sensitivity to drive forces for moving and tilting the objective lens 15 and the like, the sensitivity being about 6.7% higher than that of the comparative example shown in FIG. 13A and FIG. 13B.

As in the case where the coil units of FIG. 11A to FIG. 11D, each having an odd number of turns, are used, the coil units of each double coil shown in FIG. 12A to FIG. 12C, each having an even number of turns, are laid one on the other, after a part of one coil unit has been passed through a part of the other coil unit. Hence, the extension line 30 is not interposed between the double coils, and that is no oil height loss at all. The effective region composed of the focus coil 26 and the tilt coil 28 can therefore be fully utilized without loss. Thus, the effective region can be expanded if the double coils are laid one above the other.

The present invention can prevent not only the loss of double-coil height, but also the inclination of each double coil. To prevent the inclination, the coil units constituting each double coil need not be set in close contact. The double coils can be spaced apart.

Moreover, since the coils are arranged as shown in FIG. 11A through FIG. 11D and FIG. 12A through FIG. 12C, the extension line 30 and the leading line are connected, each extending along a side of a coil. They can therefore be led out at the same point on the coil. This makes it possible to lead the extension line 30 and the leading line smoothly to the region where the ends of the coils are processed.

Thus, the present invention can restrain the overall height of a serial coil composed of two or more coil units. The invention can also properly control the objective lens 15 in various directions.

In the comparative example, the height of any serial coil increases by the thickness of the extension line 30 if the serial coil is composed of two or more coil units that are laid one on another. Consequently, the objective-lens driving apparatus 17 having serial coils will have its overall height increased. By contrast, according to the present invention, the extension line 30 or the like is not clamped at all, and the components of the objective-lens driving apparatus 17 can therefore be effectively arranged in a space, despite the physical restriction imposed on the height of the objective-lens driving apparatus 17. The coil units are arranged as specified above in the optical pickup head 11 having the objective-lens driving apparatus 17. Therefore, the apparatus for the optical pick head 11 can be made thinner. This helps to enhance the performance of the optical pickup.

### Second Embodiment

Two double coils are laid one above the other, such that the extension line 30 of the upper serial coil and the extension line 30 of the lower serial coil are led from the same side (upper side or lower side).

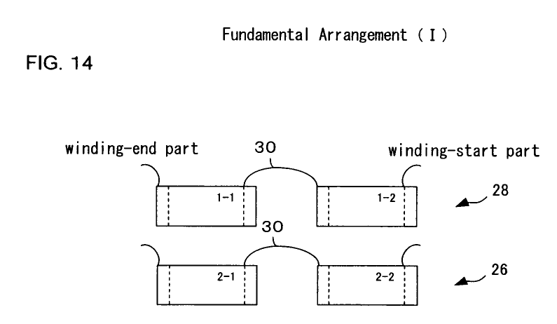

If any coil unit used has turn layers in even number, the upper extension line 30 and the lower extension line 30 are arranged on the same side of each winding as shown in FIG. 14. The arrangement of the double coils, illustrated in FIG. 14, will be hereinafter referred to as fundamental arrangement (I).

In a coil manufacturing method according to the second embodiment of the present embodiment, the tilt coil 28, i.e., two upper-stage coil units each having an even number of turns, and the focus coil 26, i.e., two lower-stage coil units each having an even number of turns, are connected by the extension line 30, and the tilt coil 28, i.e., upper-stage double coil, and the focus coil 26, i.e., lower-stage double coil, are laid one above the other. The tilt coil 28 has two leading wires formed on the same side of the winding. Similarly, the focus coil 26 has two leading wires formed on the same side of the winding.

The coil manufacturing method according to the second embodiment will be explained below.

First, the wire led outwards from the upper part of one coil unit 1-2 of the tilt coil 28, which has an even number of turns, and the wire led inwards from the upper part of the other coil unit 1-1 of the tilt coil 28, which has an even number of turns, are connected by the extension line 30.

Then, the wire led outwards from the upper part of one coil unit 2-2 of the focus coil 26, which has an even number of turns, and the wire led inwards from the upper part of the other coil unit 2-1 of the focus coil 26, which has an even number of turns, are connected by the extension line 30.

Next, the tilt coil 28 and the focus coil 26, whose coil units have been thus connected, are arranged one above the other, forming a two-stage structure, as illustrated in FIG. 14.

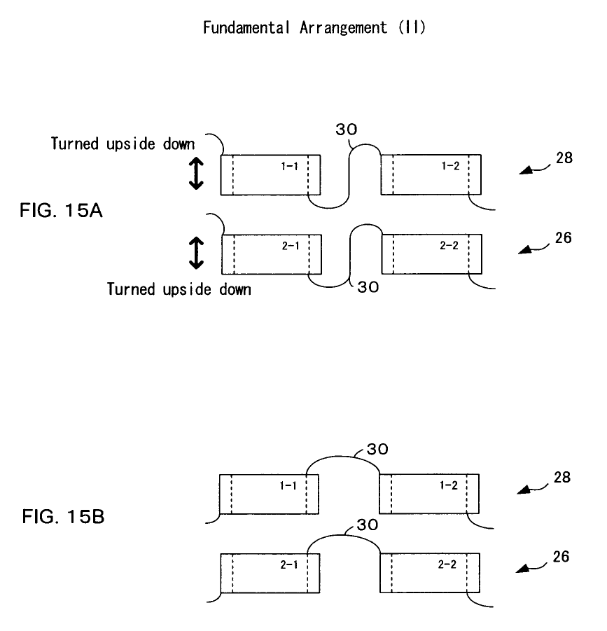

In order to arrange two double coils, each composed of two coil units each having an odd number of turns, one above the other as shown in FIG. 15A and FIG. 15B, the wire led inwards from the lower part of one coil unit 1-1 of the tilt coil 28, which has an odd number of turns, is connected to the wire led outwards from the upper part of the other coil unit 1-2 also having an odd number of turns, by the extension line 30.

Further, the wire led inwards from the lower part of one coil unit 2-1 of the focus coil 26, which has an odd number of turns, is connected to the wire led outwards from the upper part of the other coil unit 2-2 of the focus coil 26, by the extension line 30.

Next, the coil unit 1-1 of the tilt coil 28, i.e., upper-stage coil unit, and the coil unit 2-1 of the focus coil 26, i.e., lower-stage coil unit, are exchanged in position in vertical direction, as indicated by the arrow shown in FIG. 15A. Therefore, as shown in FIG. 15B, the upper extension line and the lower extension line are opposed with respect to the winding. The arrangement of the double coils, illustrated in FIG. 15B, will be hereinafter called fundamental arrangement (II).

In the coil manufacturing method according to the second embodiment, the left and right coil units constituting the tilt coil 28, i.e., upper-stage coil units each having an odd number of turns, are connected by the extension line 30, and the left and right coil units constituting the focus coil 26, i.e., lower-stage coil units each having an odd number of turns, are connected by the extension line 30. Thus, the tilt coil 28 and the focus coil 26 are arranged one above the other.

That is, the wire led outwards from the coil unit 1-2 of the tilt coil 28 is connected to the wire led inwards from the coil unit 1-1 of the tilt coil 28, by the extension line 30. The wire led outwards from the coil unit 1-1 is pulled upwards, while the wire led inwards from the coil unit 1-2 is pulled downwards.

Next, the coil unit 1-1, i.e., one of the two component units of the tilt coil 28 which have been connected by the extension line 30, is turned upside down.

The wire let outwards from the coil unit 2-2 of the focus coil 26 and the wire led inwards from the coil unit 2-1 of the focus coil 26 are connected by the extension line 30. The wire led outwards from the coil unit 2-1 is pulled upwards, while the wire led inwards from the coil unit 2-2 is pulled downwards. Then, the coil unit 2-1, i.e., one of the two component units of the focus coil 26 which have been connected by the extension line 30, is turned upside down.

Then, the tilt coil 28 and the focus coil 26 are arranged such that the tilt coil 28 with the coil unit 1-1 turned upside down and the focus coil 26 with the coil unit 2-1 turned upside down are laid one above the other, forming a two-stage structure.

In the fundamental arrangement (I), the wires led outwards from the coil units 1-1 and 2-1 are arranged on the same side as the extension line 30, and the wires led inwards from the coil units 1-2 and 2-2 are arranged on the same side as another extension line 30. By contrast, in the fundamental arrangement (II), the wires led outwards from the coil units 1-1 and 2-1 are arranged on the side opposite to the extension line 30, and the wires led inwards from the coil units 1-2 and 2-2 are arranged on the side opposite to another extension line 30. That is, the fundamental arrangement (I) assumes the characteristic of any coil having an even number of turns, because the wires led out lie above the extension lines 30. The fundamental arrangement (II) assumes the characteristic of any coil having an odd number of turns, because the wires led out lie below the extension lines 30.

Two modifications of the fundamental arrangement (I) will be described. One of the two double coils will be explained.

### (1) First Modification of the Fundamental Arrangement (I)

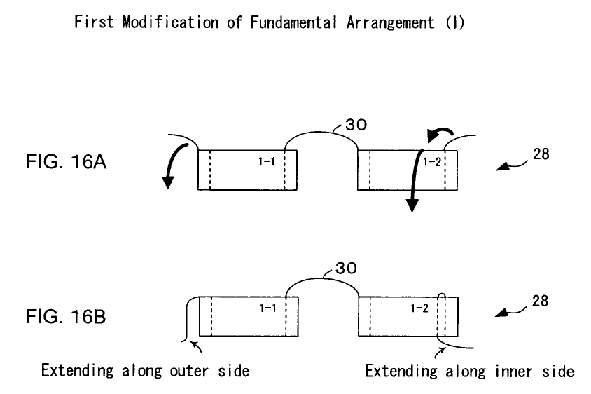

In a coil manufacturing method according to a first modification of the fundamental arrangement (I), the wire led outwards from the coil unit 1-1 of the tilt coil 28 and the wire led inwards from the coil unit 1-2 of the tilt unit 28 are pulled as described below and is illustrated in FIG. 16A.

As shown in FIG. 16B, the wire led outwards from the coil unit 1-1 is passed through the outside of the winding of the coil unit 1-1 and pulled down from the coil unit 1-1. The wire led inwards from the coil unit 1-2 is passed through the inside of the winding of the coil unit 1-2 and pulled down from the coil unit 1-2.

Thus, the tilt coil 28 is composed of two coil units 1-1 and 1-2, which have an even number of turns each and are connected to each other by the extension line 30, has the characteristic of any coil that has an odd number of turns.

The wires led from the focus coil 26 are pulled in the same way as the wires led from the tilt coil 28 shown in FIG. 16B.

The tilt coil 28 and the focus coil 26 are arranged such that the tilt coil 28 and the focus coil 26 constitute a two-stage structure.

### (2) Second Modification of the Fundamental Arrangement (I)

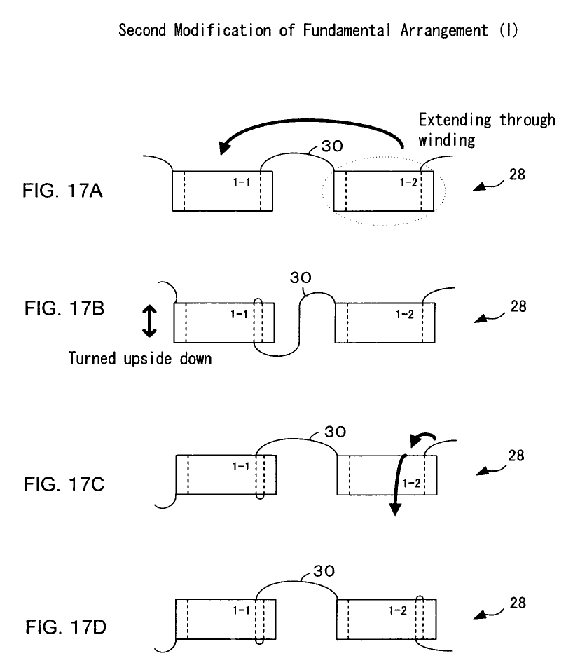

In a coil manufacturing method according to a second modification of the fundamental arrangement (I), the coil unit 1-2 of the tilt coil 28 is passed through the winding of the coil unit 1-1 from inside to outside, and the wire led inwards from the coil unit 1-1 is bent back in the winding as is illustrated in FIG. 17A. The wire led inwards from the lower side of the coil unit 1-1 and the wire led outwards from the upper side of the coil unit 1-2 are connected by the extension line 30. Then, as shown in FIG. 17B, the coil unit 1-1 is turned upside down and the extension line 30 is arranged above. As shown in FIG. 17C, the wire led inwards from the coil unit 1-2 is passed through the inside of the winding of the coil unit 1-2, bent back and pulled down from the coil unit 1-2. As a result, a double coil of such a configuration as shown in FIG. 17D is obtained. Therefore, the tilt coil 28 composed of coil units having an even number of turns has the characteristic of any coil that has an odd number of turns.

Two modifications of the fundamental arrangement (II) will be described next.

### (1) First Modification of the Fundamental Arrangement (Ii)

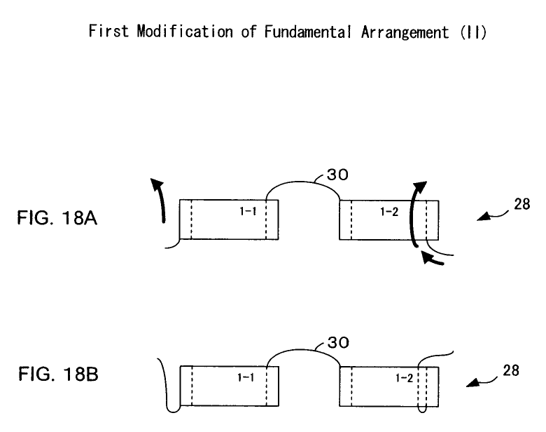

In the fundamental arrangement (II), too, wires not connected to the extension line 30 are pulled out. In a coil manufacturing method according to a first modification of the fundamental arrangement (II), the wire led outwards from the coil unit 1-1 of the tilt coil 28 is passed through the outside of the winding of the coil unit 1-1, bent back and pulled up from the coil unit 1-1 as illustrated in FIG. 18A. Then, the wire led inwards from the coil unit 1-2 is passed through the inside of the winding of the coil unit 1-2, bent back and pulled up from the coil unit 1-2. As a result, the wire led outwards from the coil unit 1-1 and the wire led inwards from the coil unit 1-2 are positioned on the same side as the extension line 30.

Thus, a double coil of such a configuration as shown in FIG. 18B is obtained. The wires led from the focus coil 26 are arranged in the same way as those led from the tilt coil 28. The tilt coil 28 and the focus coil 26 are arranged such that the tilt coil 28 and the focus coil 26 are laid one above the other.

The tilt coil 28 has the characteristic of any coil that has an even number of turns, because it is composed of coil units 1-1 and 1-2 having an add number of turns and connected by the extension line 30.

### (2) Second Modification of the Fundamental Arrangement (II)

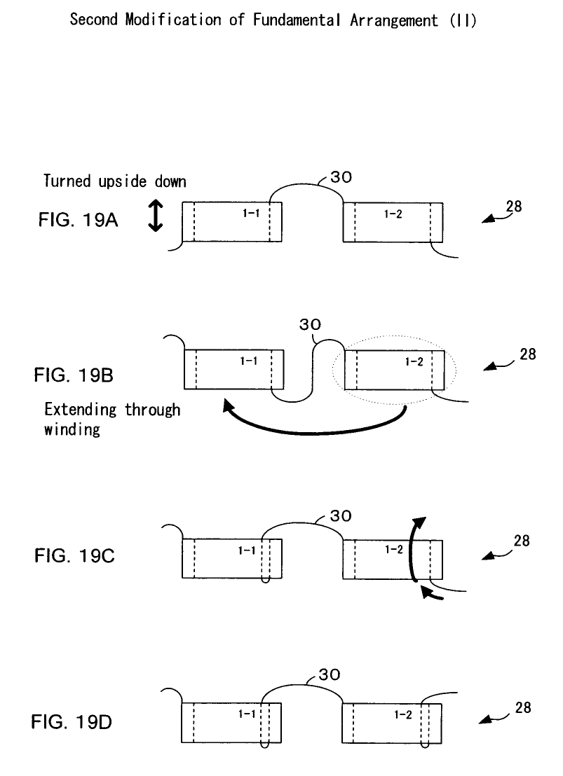

A coil manufacturing method according to the second modification of the fundamental arrangement (II) is performed as follows. As shown in FIG. 19A, the coil unit 1-1 of the tile coil 28 is turned upside down. The wire led outwards from the coil unit 1-1 is thereby pulled up. As a result, the extension line 30 connecting the coil units 1-2 and 1-1 is thereby made to extend upwards from the coil unit 1-1 to the coil unit 1-2. Then, as shown in FIG. 19B, the coil unit 1-2 is passed through the winding of the coil unit 1-1 from inside to outside, and the wire led inwards from the coil unit 1-1 is bent back. In this case, the coil unit 1-2 has a smaller area than that of the coil unit 1-1 which is defined by the inner diameter of the winding of the coil unit 1-1. The positional relation between the coil units 1-1 and 1-2 is identical to the arrangement of FIG. 15A. Further, as shown in FIG. 19C, the wire led inwards from the coil unit 1-2 is passed through the inside of the winding of the coil unit 1-2, bent back and pulled up from the coil unit 1-2. A coil of such a configuration as shown in FIG. 19D is thereby obtained. The tilt coil 28 has the characteristic of any coil that has an even number of turns, because it is composed of the coil units 1-1 and 1-2 having an odd number of turns and connected by the extension line 30.

Composed of coil units of the fundamental arrangement (I) or (II), the coil can be assembled with ease.

In some cases, the turn layers of a coil may not be easily assembled or wires may not be easily led from coil units due to the limitation to the number of turn layers or to the diameter of wires are limited.

In the present embodiment, however, coils having an even number of turns can assume an arrange fit for a coil having an odd number of turns. Alternatively, coils having an odd number of turns can assume an arrange fit for a coil having an even number of turns.

In other words, the coil manufacturing methods according to the present embodiment and the modification thereof can be characterized in that any wire led is turned an even or odd number of times (that is, above or below) with respect to the extension line 30.

The coil manufacturing methods according to the present embodiment and the modification thereof may be used to manufacture coils other than the focus coil 26 and the tilt coil 28.

The embodiments described above pertain to serial coils each composed of two coil units. Nonetheless, a serial coil can include a plurality of coil units and the extension lines 30 connecting the coil units, thus providing multi-stage coil. In the embodiments described above, two serial coils are laid one above the other, forming a two-stage structure. Instead, several serial coils may be laid one above another, forming a multi-stage structure. In the structures of FIGS. 11A to 11D and FIGS. 12A to 12C, one coil unit is passed through the winding of the other coil unit, from the inside to the outside thereof, and the one coil unit has an area smaller than that of the other coil unit which is defined by the inner diameter of the winding of the other coil unit. However, this relation in terms of area defined the inner diameter of the winding or area of either side of the coil unit is required for only a part of one serial coil α and a part of the other serial coil β.

The present invention is not limited to the embodiments described above. The components of any embodiment can be modified in various manners in reducing the invention to practice, without departing from the sprit or scope of the invention. Further, the components of any embodiment described above may be combined, if necessary, in various ways to make different inventions. For example, some of the component of any embodiment may not be used. Moreover, the components of the different embodiments may be combined in any desired fashion.

What is claimed is:

1. A coil manufacturing method comprising:
a step of laying at least two serial coils one above the other, each serial coil having an odd number of turns and being composed of at least two coil units are connected through a conductive member;
a step of connecting a wire led outwards from one of the upper-stage coil units constituting the upper-stage serial coil to a wire led inwards from the other coil unit of the upper-stage coil units;
a step of connecting a wire led outwards from one of the lower-stage coil units constituting the lower-stage serial coil to a wire led inwards from the other coil unit of the lower-stage coil units;
a step of passing one of the coil units constituting the upper-stage or lower-stage coil unit, from inside to outside through the winding of the other coil unit constituting the lower-stage or upper-stage coil unit;
a step of passing the other of the coil units constituting the lower-stage or upper-stage coil unit, from outside to inside, through the winding of the other coil unit constituting the upper-stage or lower-stage coil unit; and
a step of pulling outwards a wire led inwards from the upper-stage or lower-stage coil unit, through the winding of the opposing lower-stage or upper-stage coil unit.

2. The coil manufacturing method according to claim 1, wherein,
when the wires led outwards and wires led inwards from the two coil units constituting the upper-stage coil unit are formed on one side and other side of the windings of the upper-stage coil unit, respectively, the wire led inwards from one coil unit constituting the lower-stage coil unit is passed through the winding of the other coil unit constituting the lower-stage coil unit and is connected to the wire led inwards from the other coil unit.

3. The coil manufacturing method according to claim 1, wherein,
when the wires led outwards and wires led inwards from the two coil units constituting the upper-stage coil unit are formed on the same side of the windings of the upper-stage coil unit, the wire led outwards from one coil unit constituting the lower-stage coil unit is passed through the winding of the other coil unit constituting the lower-stage coil unit and is connected to the wire led inwards from the other coil unit.

4. The coil manufacturing method according to claim 1, wherein,
in the step of passing any coil unit through the winding of any other coil unit from inside to outside, the coil unit having an area smaller than that defined by the inner diameter of the winding of the other coil unit passes through the winding from inside to outside.

5. The coil manufacturing method according to claim 2, wherein,
in the step of passing any coil unit through the winding of any other coil unit from inside to outside, the coil unit having an area smaller than that defined by the inner diameter of the winding of the other coil unit passes through the winding from inside to outside.

6. A coil manufacturing method comprising:
a step of laying at least two serial coils one above the other, each serial coil having an even number of turns and being composed of at least two coil units are connected through a conductive member;
a step of connecting a wire led outwards from one of the upper-stage coil units constituting the upper-stage serial coil to a wire led inwards from the other coil unit of the upper-stage coil units;
a step of connecting a wire led outwards from one of the lower-stage coil units constituting the lower-stage serial coil to a wire led inwards from the other coil unit of the lower-stage coil units;
a step of passing any coil unit constituting the upper-stage or lower-stage coil unit, from inside to outside, through the winding of any coil unit constituting the lower-stage or upper-stage coil unit; and
a step of pulling outwards a wire led inwards from the upper-stage or lower-stage coil unit, through the winding of the opposing lower-stage or upper-stage coil unit.

7. A coil manufacturing method comprising:
a step of laying at least two serial coils one above the other, each serial coil being composed of at least two coil units are connected through a conductive member;
a step of connecting one of two wires led outwards from one of the upper-stage coil units constituting the upper-stage serial coil and having an even number of turns, to a wire led inwards from the other coil unit of the upper-stage coil units, the two wires being formed on the same side of a winding;
a step of connecting one of two wires led outwards from one of the lower-stage coil units constituting the lower-stage serial coil and having an even number of turns, to a wire led inwards from the other coil unit of the lower-stage coil units, the two wires being formed on the same side of a winding; and
a step of arranging the connected upper-stage coil unit and the connected lower-stage coil unit, one above the other, thereby forming a two-stage structure.

8. The coil manufacturing method according to claim 7, further comprising:
a step of passing the wire led outwards from the other upper-stage coil unit, along an outer side of the winding of the other coil unit, and pulling the wire downwards; and
a step of passing a wire led inwards from one of the upper-stage coil units, along an inner side of the winding of one of the coil units, folding back the same and pulling the same downwards.

9. The coil manufacturing method according to claim 7, further comprising:
a step of passing one of the coil unit of the upper-stage coil units through the winding of the other coil unit of the upper-stage coil units, from inside to outside;
a step of turning the coil unit of the other upper-stage coil unit upside down; and
a step of passing a wire led inwards from one of the coil unit of the upper-stage coil units, through the winding of one of the coil units, folding back the same and pulling the same downwards.

10. A coil manufacturing method comprising:
a step of laying at least two serial coils one above the other, each being composed of at least two coil units are connected through a conductive member;
a step of connecting one of two wires led outwards from one of the upper-stage coil units constituting the upper-stage serial coil and having an odd number of turns, to a wire led inwards from the other coil unit of the upper-stage coil unit, the two wires being formed on opposite sides of a winding;
a step of turning one of the coil unit of the upper-stage coil units upside down; and
a step of connecting one of two wires led outwards from one of the lower-stage coil units constituting the lower-stage serial coil and having an odd number of turns, to a wire led inwards from the other coil unit of the lower-stage coil units, the two wires being formed on the opposite sides of a winding;
a step of turning one of the coil unit of the lower-stage coil units upside down; and
a step of arranging the upper-stage coil unit and the lower-stage coil unit, one above the other in the same shape, thereby forming a two-stage structure.

11. The coil manufacturing method according to claim 10, further comprising:
a step of passing a wire led inwards from one of the upper-stage coil units, through the winding of one of the coil units, folding back the same and pulling the same upwards.

12. The coil manufacturing method according to claim 10, further comprising:
a step of turning the other coil unit of the upper-stage coil units upside down;
a step of passing one of the coil unit of the upper-stage coil units through the winding of the other coil unit, from inside to outside; and
a step of passing a wire led inwards from one coil unit, through the winding of the one coil unit, folding back the same and pulling the same upwards.

13. An apparatus for driving an objective lens comprising:
a focus coil which includes two coil units having a winding each, a wire led from the winding of one coil unit, and another wire led into the winding of other coil unit, and which is configured to generate Lorentz's force for adjusting the displacement of the objective lens in a focusing direction with respect to an optical disk;
a tilt coil which includes two coil units having a winding each, a wire led from the winding of one coil unit, and another wire led into the winding of the other coil unit, and which is configured to generate Lorentz's force for adjusting the inclination of the objective lens with respect to the optical disk;
a lens holder which holds the objective lens, allowing the same to move, and which holds the focus coil and the tilt coil, allowing both to be removed; and
drive means for making the focus coil and the tilt coil generate Lorentz's force, thereby to drive the objective lens, in at least a focusing direction and a tilting direction,
wherein the two coil units constituting the focus coil and the two coil units constituting the tilt coil are connected through conductive members, and are arrange one above another, forming a two-stage structure; and
the wire led outwards or inwards from one of the coil units of the tilt coil is passed through the winding of that coil unit of the focus coil, which is other than the coil unit laid above the one of the coil units of the tilt coil, and is then connected to the wire led inwards from the other coil unit of the tilt coil.

14. The apparatus for driving an objective lens, according to claim 13, wherein the wire led outwards and the wire led inwards are formed at almost the same position in the lens holder.

15. The apparatus for driving an objective lens, according to claim 13, wherein a line member connecting the two coil units constituting the focus coil and a line member connecting the two coil units constituting the tilt coil are formed at almost the same position in the lens holder.

16. The apparatus for driving an objective lens, according to claim 13, wherein the other of the two coils constituting the focus coil has a winding having a substantially rectangular cross section that has inner diameter A×inner diameter B (A≦B);
the one of the two coil units constituting the tilt coil has a winding having two sides that have lengths C and D, respectively (C≦D); and
the length C of the side is equal to or smaller than the inner diameter A (C≦A) and the length D of the other side is equal to or smaller than the inner diameter B (D≦B).

17. The apparatus for driving an objective lens, according to claim 13, wherein the focus coil and the tilt coil are set in close contact with each other.

18. The apparatus for driving an objective lens, according to claim 13, wherein the focus coil and the tilt coil are spaced apart from each other.

19. The apparatus for driving an objective lens, according to claim 13, wherein the focus coil or the tilt coil is manufactured by the coil manufacturing method described in claim 7.

20. The apparatus for driving an objective lens, according to claim 13, wherein the focus coil or the tilt coil is manufactured by the coil manufacturing method described in claim 10.
